(19) United States
(12) Patent Application Publication
(10) Pub. No.: US 2026/0197038 A1
(43) Pub. Date: Jul. 9, 2026

(54) STEPWISE-SIMULATION-BASED RAY TRACING MODELING METHOD AND SYSTEM FOR RECONFIGURABLE INTELLIGENT SURFACE CHANNEL

(71) Applicant: NANJING JIEXI TECHNOLOGY CO., LTD., Jiangsu (CN)

(72) Inventors: Chengxiang WANG, Jiangsu (CN); Jialing HUANG, Jiangsu (CN); Songjiang YANG, Jiangsu (CN); Yinghua WANG, Jiangsu (CN); Jie HUANG, Jiangsu (CN); Fuchun ZHENG, Jiangsu (CN); Baohua CAO, Jiangsu (CN); Xiaocong WANG, Jiangsu (CN)

(73) Assignee: NANJING JIEXI TECHNOLOGY CO., LTD., Jiangsu (CN)

(21) Appl. No.: 19/550,266

(22) Filed: Feb. 26, 2026

Related U.S. Application Data
(63) Continuation of application No. PCT/CN2023/126703, filed on Oct. 26, 2023.

(30) Foreign Application Priority Data
Aug. 28, 2023 (CN) 202311084059.9

(51) Int. Cl. H04B 7/04; H04B 17/391

(52) U.S. Cl. CPC H04B 7/04013; H04B 17/391

(57) ABSTRACT

Provided in the present invention are a stepwise-simulation-based ray tracing modeling method and system for a reconfigurable intelligent surface (RIS) channel. The method comprises: constructing a simulation scenario, and setting simulation parameters; verifying a simulation environment layout; constructing an RIS; classifying multipaths; performing stepwise simulation to acquire multipath information; extracting a channel impulse response of the RIS; on the basis of multipath information of a first multipath and multipath information of a second multipath, extracting a channel impulse response of a cascade link of a base station, the RIS and a user to obtain a path loss, a delay power spectral density and an angular power spectral density, so as to analyze channel characteristics of an RIS channel in a delay domain and an angular domain. The present invention supports RIS channel simulation in any frequency band and any scenario, such that deterministic modeling methods for RISs are enriched.

### CROSS-REFERENCE TO RELATED APPLICATION

This application is a continuation of international application of PCT application serial no. PCT/CN2023/126703 filed on Oct. 26, 2023, which claims the priority benefit of China application no. 202311084059.9 filed on Aug. 28, 2023. The entirety of each of the above-mentioned patent applications is hereby incorporated by reference herein and made a part of this specification.

### TECHNICAL FIELD

The present invention belongs to the technical field of channel modeling, and in particular to a stepwise-simulation-based ray tracing modeling method and system for a reconfigurable intelligent surface (RIS) channel.

### BACKGROUND

In order to realize the vision of full coverage, full spectrum, full application, full sensory experience, full digitalization, and strong security of the sixth-generation (6G) mobile communication system, key enabling technologies such as extremely large-scale multiple-input-multiple-output (MIMO) technology and terahertz communication will be applied to future mobile communication systems. Base stations (BS) are equipped with extremely large-scale MIMO antenna arrays to improve spatial resolution and enhance system capacity, but this also increases power consumption, hardware expenditure, and maintenance costs. Although terahertz communication can support ultra-high transmission rates, problems such as high path loss (PL) and poor diffraction capability severely limit wireless communication distance and application scenarios. Reconfigurable intelligent surface (RIS), also known as intelligent metasurface, stands out among many key 6G technologies by virtue of its programmable characteristics, low energy consumption, and ease of deployment, and has become a potential solution for future wireless networks.

The wireless channel is a medium through which signals propagate in space. The introduction of the emerging technology RIS has broken the uncontrollability of traditional channels, enabling the channels to exhibit different channel characteristics in different application frequency bands and scenarios. An accurate and effective channel model is fundamental to studying the channel characteristics. Therefore, the system design, theoretical analysis, performance evaluation, optimization, and location deployment of wireless communication systems incorporating RIS all urgently require reliable RIS channel models for support. Traditional wireless channel research generally includes the following steps: first, obtaining the channel impulse response (CIR) of the actual wireless propagation environment by conducting on-site channel measurements; second, estimating channel parameters using channel estimation algorithms such as the space-alternating generalized expectation-maximization (SAGE) algorithm to obtain channel parameters; third, analyzing channel characteristic according to the obtained CIR and channel parameters to reveal channel characteristics; and finally, constructing a channel model and verifying the accuracy of the model by comparing the channel characteristics of the model with measurement results.

However, RIS channel measurement faces some challenges at present. First, RIS devices themselves are still in the design and research and development stage, are expensive, and are not yet mature. Second, the directional reflection characteristics of RIS depend on the design of RIS code, and the design of RIS code in turn depends on precise position information among the transmitting end, the receiving end, and the RIS. In the actual measurement process, the better the directional reflection performance of RIS, the narrower its main lobe width, and even slight deviations in position layout will make the receiving end difficult to receive signals normally. In addition, high-performance channel sounders are costly. Therefore, channel measurement of RIS channel is not easy to carry out.

### SUMMARY

In view of the deficiencies in the prior art, the present invention provides a stepwise-simulation-based ray tracing modeling method and system for a reconfigurable intelligent surface (RIS) channel.

In a first aspect, the present invention provides a stepwise-simulation-based ray tracing modeling method for a reconfigurable intelligent surface (RIS) channel, including:
determining a simulation environment layout and a material to be used, so as to draw a simulation environment;
determining antenna parameters, a transceiving end layout and a signal center frequency to complete simulation configuration;
determining deployment position and size of an RIS to complete the construction of the RIS;
determining whether a transmitted signal is reflected via the RIS;
if a transmitted signal is reflected via the RIS, using a multipath where the transmitted signal reaches a user after being reflected via the RIS as a first multipath;
if a transmitted signal is not reflected via the RIS, using a multipath where the transmitted signal reaches the user without being reflected via the RIS as a second multipath;
performing stepwise simulation to acquire multipath information of the first multipath, where the multipath information includes phase, delay and power of the multipath;
configuring the RIS to be made of a wave-absorbing material, setting a transmitting antenna at a transmitting end and a receiving antenna at a receiving end to be in an operating state, setting a receiving antenna and a transmitting antenna at the RIS to be in a non-operating state, and simulating a cascade link of a base station, the RIS and the user, so as to acquire multipath information of the second multipath; and
on the basis of the multipath information of the first multipath and the multipath information of the second multipath, extracting a channel impulse response of the cascade link of the base station, the RIS and the user to obtain a path loss, a delay power spectral density and an angular power spectral density, so as to analyze channel characteristics of a reconfigurable intelligent surface channel in a delay domain and an angular domain.

Further, the determining antenna parameters, a transceiving end layout and a signal center frequency to complete simulation configuration includes:
determining an antenna type, an antenna polarization mode and an antenna ray-tracing range, point layouts of a transmitting end and a receiving end, a transmitting antenna type matched with the transmitting end, a receiving antenna type matched with the receiving end, a received power threshold of the receiving end, a transmitted signal type, a transmitted signal center frequency, and a transmitted signal bandwidth in the simulation environment;
determining a dielectric constant of the material according to the transmitted signal center frequency to complete simulation configuration;
setting simulation propagation mechanisms and a maximum order of each propagation mechanism; and
setting output simulation results, where the simulation results include three types of multipath information, namely multipath phase, delay, and power, as well as azimuth angle of arrival and elevation angle of arrival.

Further, the determining deployment position and size of an RIS to complete the construction of the RIS includes:
arranging receiving points on the RIS at half-wavelength intervals to obtain received power at the RIS; and
setting a transmitting point at a center of the RIS to acquire multipath information of the first multipath.

Further, the performing stepwise simulation to acquire multipath information of the first multipath includes:
setting a transmitting antenna at the transmitting end and a receiving antenna at the RIS to be in an operating state, setting a transmitting antenna at the RIS and a receiving antenna at the receiving end to be in a non-operating state, and performing base station-RIS segment simulation; and
obtaining received power and phase of each receiving point on the RIS from the base station through simulation;
a total received power P_{RIS} at the RIS is calculated according to the following formula:

$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$

where M denotes a total number of rows of receiving points in a horizontal direction of the RIS, N denotes a total number of columns of receiving points in a vertical direction of the RIS, the RIS includes a total of M×N receiving points; P_{m,n} denotes received power of a receiving point in an m^{th} row and an n^{th} column of the RIS; φ_{m,n} denotes a phase of the receiving point in the m^{th} row and the n^{th} column of the RIS; and Φm, n denotes a coding phase of the receiving point in the m^{th} row and the n^{th} column of the RIS; and Φ_{m,n}=mod(k(v_{m,n}v^{T}−v_{m,n}v^{R}),2π), where k denotes a wave number, k=2π/λ, λ denotes a wavelength, v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to a user; e is a natural constant; and j is an imaginary unit;
simulating a link of the RIS and the user by taking the RIS as a secondary transmitting source, and a direction of a line connecting the RIS and the user as a reflection direction, a main lobe width of the RIS as a ray-tracing range, thereby obtaining the first multipath that reaches the user after being reflected via the RIS;
a total delay of the first multipath τ_{MP}_{_{RIS}} is calculated according to the following formula:

$${τ}_{{MP}_{RIS}} = {τ}_{RIS - UE} + \frac{{d}_{O}^{R}}{c} ;$$

where τ_{RIS-UE} denotes a delay of each multipath in the first multipath on an RIS-user segment; c denotes a speed of light; and

$${d}_{O}^{R}$$

denotes a distance from a center O of the base station to a center R of the RIS.

Further, the on the basis of the multipath information of the first multipath and the multipath information of the second multipath, extracting a channel impulse response of the cascade link of the base station, the RIS and the user to obtain a path loss, a delay power spectral density and an angular power spectral density, so as to analyze channel characteristics of a reconfigurable intelligent surface channel in a delay domain and an angular domain includes:
constructing a channel transfer function H_{i,q}(f) of an i^{th} transmitting antenna and a q^{th} receiving antenna pair to characterize signal attenuation and distortion during transmission:

$${H}_{i , q} ( f ) = {\sum }_{l = 1}^{L} \sqrt{{p}_{l}} {e}^{j {φ}_{l}} {e}^{- j 2 π f {τ}_{l}} ;$$

where L denotes a total number of multipaths between the i^{th} transmitting antenna and the q^{th} receiving antenna; the multipaths between the i^{th} transmitting antenna and the q^{th} receiving antenna include the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal, e is a natural constant, and j is an imaginary unit.
performing frequency-domain sampling on H_{i,q}(f) according to a bandwidth of the transmit signal and a time-domain signal length to obtain a discrete channel transfer function;
performing an inverse fast Fourier transform on the discrete channel transfer function to obtain a channel impulse response h_{i,q} of the i^{th} transmitting antenna and the q^{th} receiving antenna pair with the same sampling rate and length as verification data;
averaging channel impulse responses of different receiving antenna pairs along an antenna dimension, and calculating a channel impulse response h(t) between the transmitting end and the receiving end according to the following formula:

$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$

where N_{Tx} denotes a number of antenna arrays at the transmitting end; and N_{Rx} denotes a number of antenna arrays at the receiving end.

In a second aspect, the present invention provides a stepwise-simulation-based ray tracing modeling system for a reconfigurable intelligent surface (RIS) channel, including:
a simulation environment drawing module, configured to determine a simulation environment layout and a material to be used, so as to draw a simulation environment;
a simulation configuration completion module, configured to determine antenna parameters, a transceiving end layout and a signal center frequency to complete simulation configuration;
an RIS construction module, configured to determine deployment position and size of an RIS to complete the construction of the RIS;
a determining module, configured to determine whether a transmitted signal is reflected via the RIS;
a first determination module, configured to determine a multipath where the transmitted signal reaches a user after being reflected via the RIS as a first multipath when a transmitted signal is reflected via the RIS;
a second determination module, configured to determine a multipath where the transmitted signal reaches the user without being reflected via the RIS as a second multipath when a transmitted signal is not reflected via the RIS;
a first multipath information acquisition module, configured to perform stepwise simulation to acquire multipath information of the first multipath, where the multipath information includes phase, delay and power of the multipath;
a second multipath information acquisition module, configured to configure the RIS to be made of a wave-absorbing material, set a transmitting antenna at a transmitting end and a receiving antenna at a receiving end to be in an operating state, set a receiving antenna and a transmitting antenna at the RIS to be in a non-operating state, and simulate a cascade link of a base station, the RIS and the user, so as to acquire multipath information of the second multipath; and
a channel characteristic analysis module, configured to extract a channel impulse response of the cascade link of the base station, the RIS and the user to obtain a path loss, a delay power spectral density and an angular power spectral density on the basis of the multipath information of the first multipath and the multipath information of the second multipath, so as to analyze channel characteristics of a reconfigurable intelligent surface channel in a delay domain and an angular domain.

Further, the simulation configuration completion module includes:
a first determination unit, configured to determine an antenna type, an antenna polarization mode and an antenna ray-tracing range, point layouts of a transmitting end and a receiving end, a transmitting antenna type matched with the transmitting end, a receiving antenna type matched with the receiving end, a received power threshold of the receiving end, a transmitted signal type, a transmitted signal center frequency, and a transmitted signal bandwidth in the simulation environment;
a second determination unit, configured to determine a dielectric constant of the material according to the transmitted signal center frequency to complete simulation configuration;
a first setting unit, configured to set simulation propagation mechanisms and a maximum order of each propagation mechanism; and
a second setting unit, configured to set output simulation results, where the simulation results include three types of multipath information, namely multipath phase, delay, and power, as well as azimuth angle of arrival and elevation angle of arrival.

Further, the RIS construction module includes:
a received power acquisition unit, configured to arrange receiving points on the RIS at half-wavelength intervals to obtain received power at the RIS; and
a first multipath information acquisition unit, configured to set a transmitting point at a center of the RIS to acquire multipath information of the first multipath.

Further, the first multipath information acquisition module includes:
a first simulation unit, configured to set a transmitting antenna at the transmitting end and a receiving antenna at the RIS to be in an operating state, set a transmitting antenna at the RIS and a receiving antenna at the receiving end to be in a non-operating state, and perform base station-RIS segment simulation;
a second simulation unit, configured to obtain received power and phase of each receiving point on the RIS from the base station through simulation; and
a first calculation unit, configured to calculate a total received power P_{RIS} at the RIS according to the following formula:

$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$

where M denotes a total number of rows of receiving points in a horizontal direction of the RIS, N denotes a total number of columns of receiving points in a vertical direction of the RIS, the RIS includes a total of M×N receiving points; P_{m,n} denotes received power of a receiving point in an m^{th} row and an n^{th} column of the RIS; P_{m,n} denotes a phase of the receiving point in the m^{th} row and the n^{th} column of the RIS; and Φ_{m,n} denotes a coding phase of the receiving point in the m^{th} row and the n^{th} column of the RIS; and Φ_{m,n}=mod(k(v_{m,n}v^{T}−v_{m,n}v^{R}),2π), where k denotes a wave number, k=2π/λ, λ denotes a wavelength, v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to a user; e is a natural constant; and j is an imaginary unit;
a third simulation unit, configured to simulate a link of the RIS and the user by taking the RIS as a secondary transmitting source, and a direction of a line connecting the RIS and the user as a reflection direction, a main lobe width of the RIS as a ray-tracing range, thereby obtaining the first multipath that reaches the user after being reflected via the RIS.

A second calculation unit, configured to calculate a total delay of the first multipath τ_{MP}_{_{RIS}} according to the following formula:

$${τ}_{{MP}_{RIS}} = {τ}_{RIS - UE} + \frac{{d}_{O}^{R}}{c} ;$$

where τ_{RIS-UE} denotes a delay of each multipath in the first multipath on an RIS-user segment; c denotes a speed of light; and

$${d}_{O}^{R}$$

denotes a distance from a center O of the base station to a center R of the RIS.

Further, the channel characteristic analysis module includes:
a construction unit, configured to construct a channel transfer function H_{i,q}(f) of an i^{th} transmitting antenna and a q^{th} receiving antenna pair to characterize signal attenuation and distortion during transmission:

$${H}_{i , q} ( f ) = {\sum }_{l = 1}^{L} \sqrt{{p}_{l}} {e}^{j {φ}_{l}} {e}^{- j 2 π f {τ}_{l}} ;$$

where L denotes a total number of multipaths between the i^{th} transmitting antenna and the q^{th} receiving antenna; the multipaths between the i^{th} transmitting antenna and the q^{th} receiving antenna include the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal; e is a natural constant, and j is an imaginary unit.
a frequency-domain sampling unit, configured to perform frequency-domain sampling on H_{i,q}(f) according to a bandwidth of the transmit signal and a time-domain signal length to obtain a discrete channel transfer function;
an inverse fast Fourier transform unit, configured to perform an inverse fast Fourier transform on the discrete channel transfer function to obtain a channel impulse response h_{i,q} of the i^{th} transmitting antenna and the q^{th} receiving antenna pair with the same sampling rate and length as verification data; and
a third calculation unit, configured to average channel impulse responses of different receiving antenna pairs along an antenna dimension, and calculate a channel impulse response h(t) between the transmitting end and the receiving end according to the following formula:

$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$

where N_{Tx} denotes a number of antenna arrays at the transmitting end; and N_{Rx} denotes a number of antenna arrays at the receiving end.

The present invention provides a stepwise-simulation-based ray tracing modeling method and system for a reconfigurable intelligent surface (RIS) channel. The method enables realization of directional reflection characteristics of an RIS in static ray-tracing simulation software. A unit size of the RIS is strictly designed in accordance with the theoretical half-wavelength requirements. In addition, any number of RIS units may be deployed at any position in an environment and arranged in any configuration. The method further enables RIS channel ray-tracing simulation for any frequency band and any scenario, thereby acquiring RIS channel parameters with less manpower, fewer material resources and lower time costs, and the RIS channel characteristics may thus be analyzed, providing a foundation for practical application of RISs in communication systems.

### BRIEF DESCRIPTION OF THE DRAWINGS

In order to more clearly illustrate the technical solution of the present invention, the accompanying drawings required to be used in the description of some embodiments are simply introduced below, and obviously, the accompanying drawings described below are only some embodiments of the present invention, such that for those of ordinary skill in the art, other drawings may further be derived from these drawings without making inventive efforts.

FIG. 1 is a flowchart of a stepwise-simulation-based ray tracing modeling method for a reconfigurable intelligent surface (RIS) channel according to an embodiment of the present invention.

FIG. 2 is a schematic diagram of multipath classification according to an embodiment of the present invention.

FIG. 3 is a schematic diagram illustrating an incident path and a reflected path of an RIS according to an embodiment of the present invention.

FIG. 4 is a schematic diagram of an RIS simulation scenario according to an embodiment of the present invention.

FIG. 5 is a fitting plot between path loss and measurement data for UE1-UE20 according to an embodiment of the present invention.

FIG. 6 is an absolute error plot between path loss and measurement data for UE1-UE20 according to an embodiment of the present invention.

FIG. 7 is a fitting plot between a delay power spectral density and measurement data for UE1 in an RIS mirror-arranged state according to an embodiment of the present invention.

FIG. 8 is a fitting plot between a delay power spectral density and measurement data for UE5 in an RIS non-mirror-arranged state according to an embodiment of the present invention.

FIG. 9 is an angular power spectral density plot of UE2 in an RIS mirror-arranged state according to an embodiment of the present invention.

FIG. 10 is an angular power spectral density plot of UE5 in an RIS non-mirror-arranged state according to an embodiment of the present invention.

FIG. 11 is a structural diagram of a stepwise-simulation-based ray tracing modeling system for a reconfigurable intelligent surface (RIS) channel according to an embodiment of the present invention.

### DETAILED DESCRIPTIONS OF THE EMBODIMENTS

The technical solutions of embodiments of the present invention will be described below clearly and comprehensively in conjunction with accompanying drawings of the embodiments of the present invention. Apparently, the embodiments described are merely some embodiments rather than all embodiments of the present invention. On the basis of the embodiments in the present invention, all other embodiments acquired by those of ordinary skill in the art without making creative efforts fall within the scope of protection of the present invention.

Deterministic channel modeling and simulation analysis based on ray tracing (RT) are expected to overcome current difficulties in reconfigurable intelligent surface (RIS) channel measurement. Ray tracing is based on geometric optics (GO) and the uniform theory of diffraction (UTD), enabling the search propagation paths of electromagnetic waves under different propagation mechanisms such as line-of-sight (LOS) propagation, reflection, and diffraction. Although current ray-tracing simulation software itself cannot yet break through the law of reflection in geometric optics to realize the directional reflection characteristics of RIS, as long as reasonable and effective RIS modeling and simulation methods are proposed, together with the advantages of high computational efficiency and flexible parameter configuration of ray-tracing simulation software, RIS channel modeling and simulation in any frequency band and any scenario can be realized, so that RIS channel information can be obtained with relatively low manpower, material resources, and time costs, thereby analyzing channel characteristics and laying a foundation for future deployment and application of RIS in practical application scenarios, which is of far-reaching significance.

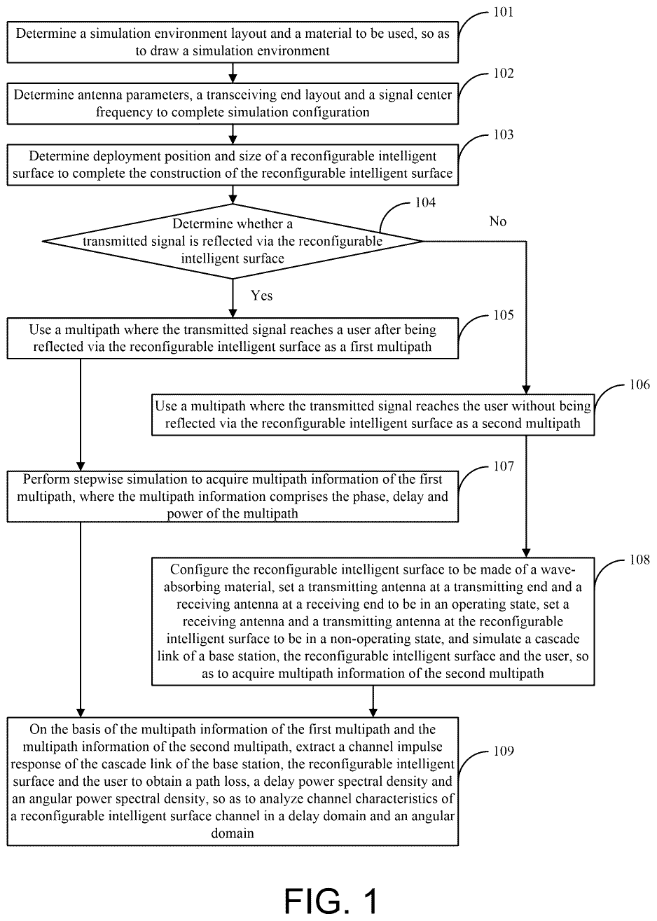

In one embodiment, as shown in FIG. 1, the present invention provides a stepwise-simulation-based ray tracing modeling method for a reconfigurable intelligent surface (RIS) channel, including:
step 101. determining a simulation environment layout and a material to be used, so as to draw a simulation environment.

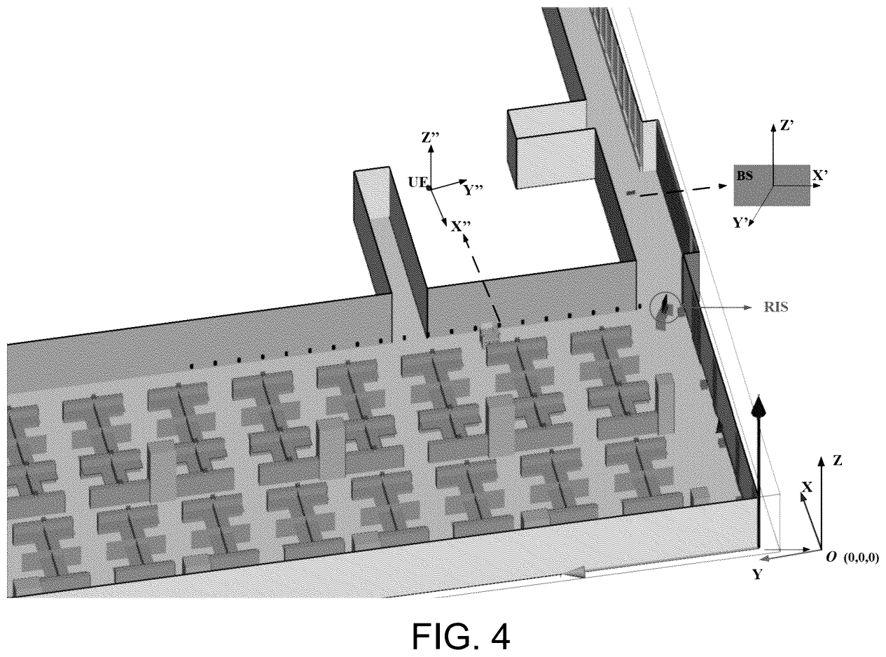

By way of example, a deterministic channel modeling method based on ray tracing is adopted. First, an application scenario is determined to be an “L”-shaped office area, and a test environment is shown in FIG. 4. The test environment includes a public office area of 18.8×40×3.3 m³ connected to a corridor of 2.4×32×3.3 m³. One side wall of the corridor is made of concrete and metal materials, and the other side is made of transparent glass and wooden materials. Two ends of the public office area are separated by transparent glass and wooden doors of conference rooms, and a middle area mainly includes neatly arranged desks, chairs and load-bearing columns. The desks, areas surrounding the load-bearing columns, and the wall on one side of the corridor are mostly made of metal materials, and transparent glass windows are installed on the other side. In addition, in order to place metal plates and an RIS for measurement, a wooden table with a height of approximately 0.8 m and a length of approximately 1.2 m is placed at a corner between the office area and the corridor. Material parameters of walls, windows, doors, floors, and the like are also determined.
Step 102. determining antenna parameters, a transceiving end layout and a signal center frequency to complete simulation configuration.

By way of example, the base station (BS) adopts a 4×8 dual-polarized array antenna, and the BS position is fixed in the corridor and remains unchanged. A user equipment (UE) adopts a dual-polarized cylindrical array antenna and traverses 20 points in an aisle of the office area, where the points are uniformly arranged at intervals of 1.2 m, and centers of all UEs, BSs, and RISs are kept at the same height.

In this embodiment, the parameter setting for antenna, transceiving end layout, and signal waveform parameter includes:
Step 1021, determining an antenna type, an antenna polarization mode and an antenna ray-tracing range, point layouts of a transmitting end and a receiving end, a transmitting antenna type matched with the transmitting end, a receiving antenna type matched with the receiving end, a received power threshold of the receiving end, a transmitted signal type, a transmitted signal center frequency, and a transmitted signal bandwidth in the simulation environment (according to the determined application scenario).

As shown in FIG. 4, a global coordinate system takes a lower right vertex of the scenario as an origin O. Extension directions of two side walls are positive directions of an X-axis and a Y-axis, respectively, and a Z-axis is perpendicular to a ground. Coordinates of the BS are (26, 1.2, 1.3) in the global coordinate system. A BS local coordinate system takes a BS center as an origin O′, a direction of a line connecting the BS center and an RIS center as a positive direction of a Y′-axis, a direction perpendicular to the ground as a positive direction of a-Z′ axis, and a direction of an X′-axis direction is perpendicular to the Y′-axis and the Z′-axis. A UE local coordinate system takes a UE center as an origin, a direction of a line connecting the UE center and the RIS center as a positive direction of a Y″-axis, a direction perpendicular to the ground as a positive direction of a-Z″ axis, and an X″-axis direction perpendicular to the Y″-axis and the Z″-axis.

With the BS local coordinate system as a reference, a horizontal range of 0°-180° and a vertical range of 0°-180° are set as ray emission ranges, and rays are uniformly emitted at intervals of 0.25° for path finding. Coordinates of UE1 in the global coordinate system are (17.6, 2.4, 1.3). Starting from UE1, one receiving point is placed every 1.2 m along the positive direction of the Y-axis of the global coordinate system, for a total of 20 points (UE1-UE20). The above coordinate units are meters. The transmitting end sends a signal center frequency of 5.4 GHz, and a signal bandwidth of 160 MHz.
Step 1022. determining a dielectric constant of the material according to the transmitted signal center frequency to complete simulation configuration.

Based on the center frequency of 5.4 GHz, the dielectric constants of materials such as glass, gypsum board, ceramic tile, and metal used in the environment are corrected to complete the simulation configuration.
Step S1023. setting simulation propagation mechanisms and a maximum order of each propagation mechanism.

Reflection and diffraction mechanisms are considered. By way of example, a maximum reflection order is 3, and a maximum diffraction order is 1.
Step S1024. setting output simulation results, where the simulation results include three types of multipath information, namely multipath phase, delay, and power, as well as azimuth angle of arrival and elevation angle of arrival.
Step 103. determining deployment position and size of an RIS to complete the construction of the RIS;

In this embodiment, ray-tracing simulation is performed in a scenario where no RIS is deployed, and the path loss obtained from the simulation is compared with actual measurement data, and verification is performed between them to ensure the accuracy of scenario construction.

By way of example, the RIS includes 24×24 units, with a size of 624×624 mm². A working angle range is two-dimensional±60°, and a horizontal 3-dB bandwidth is approximately 14°. Coordinates of a center of the RIS are (17.6, 1.2, 1.3), in meters.

On an RIS panel plane, 24×24 receiving points are placed at half-wavelength intervals to acquire received power at the RIS. At a center of the RIS, one transmitting point is placed for subsequent RIS-UE link simulation.
Step 104. determining whether a transmitted signal is reflected via the RIS.

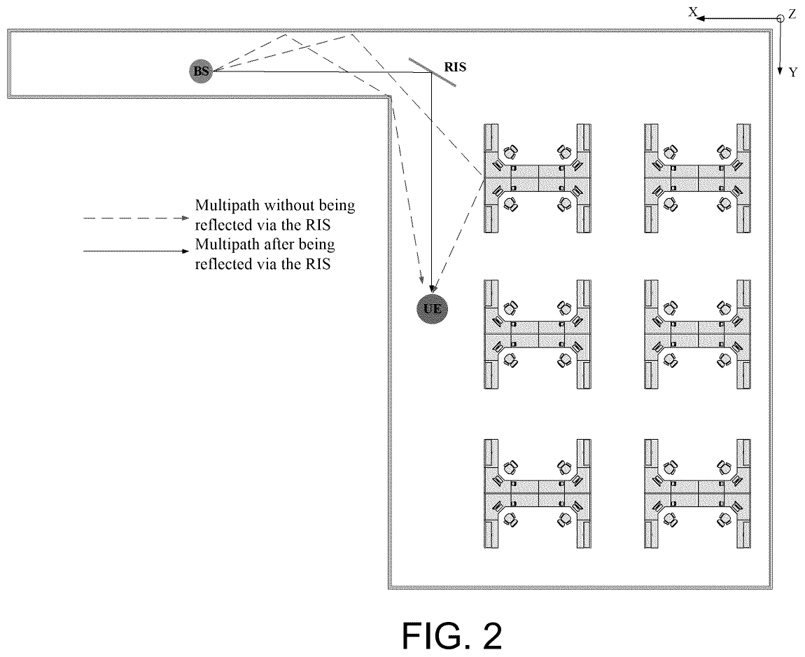

As shown in FIG. 2, multipath components in a propagation environment are classified according to whether they are reflected by an RIS. One type is multipath MP_{RIS} that arrives at the UE after directional reflection by the RIS; and another type is multipath MP_{non-RIS} that does not interact with the RIS and arrives at the UE via multiple reflections or diffractions from other facets in the environment.
Step 105. when a transmitted signal is reflected via the RIS, using a multipath where the transmitted signal reaches a user after being reflected via the RIS as a first multipath.
Step 106. when a transmitted signal is not reflected via the RIS, using a multipath where the transmitted signal reaches the user without being reflected via the RIS as a second multipath.
Step 107. performing stepwise simulation to acquire multipath information of the first multipath, where the multipath information includes phase, delay and power of the multipath.

By way of example, this step includes setting a transmitting antenna at the transmitting end and a receiving antenna at the RIS to be in an operating state, setting a transmitting antenna at the RIS and a receiving antenna at the receiving end to be in a non-operating state, and performing base station-RIS segment simulation. 24 receiving points are arranged in each of horizontal and vertical directions of the RIS panel, with a total of 576 receiving points.

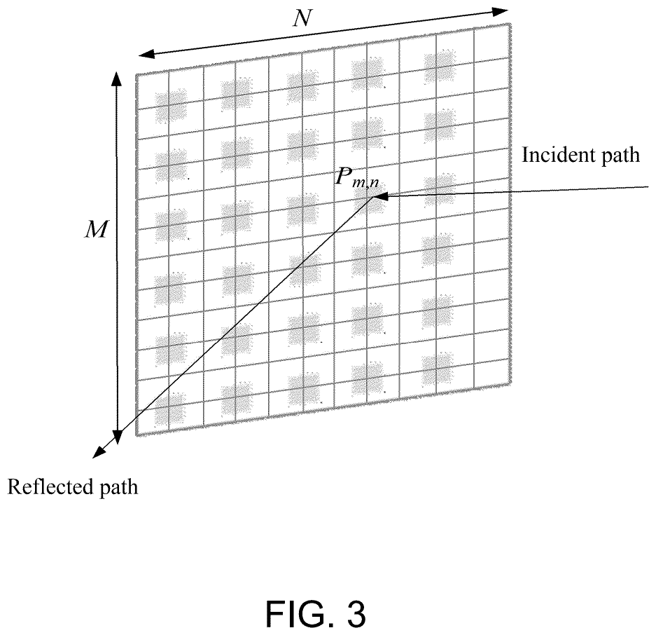

Received power and phase of each receiving point on the RIS from the base station are obtained through simulation. Thereafter, phases obtained by the optimal RIS coding are superimposed in Matlab to calculate total received power at the RIS.
a total received power PRs at the RIS is calculated according to the following formula:

$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$

where M denotes a total number of rows of receiving points in a horizontal direction of the RIS, and N denotes a total number of columns of receiving points in a vertical direction of the RIS. As shown in FIG. 3, the RIS includes a total of M×N receiving points; P_{m,n} denotes received power of a receiving point in an m^{th} row and an n^{th} column of the RIS; φ_{m,n} denotes a phase of the receiving point in the m^{th} row and the n^{th} column of the RIS; Φ_{m,n} denotes a coding phase of the receiving point in the m^{th} row and the n^{th} column of the RIS. Since current ray-tracing simulation software is based on a far-field assumption, a far-field coding method is adopted, Φ_{m,n}=mod(k(v_{m,n}v^{T}−v_{m,n}v^{R}),2π), where k denotes a wave number, k=2π/λ, λ denotes a wavelength; v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to a user; and e is a natural constant, and j is an imaginary unit.

The RIS is taken as a secondary transmitting source, and a direction of a line connecting the RIS and the user is taken as a reflection direction. A main lobe width of the RIS (horizontal ±7°, elevation ±60°) is taken as a ray-tracing range to simulate a link of the RIS and the user, thereby obtaining the first multipath MP_{RIS} that reaches the user after being reflected via the RIS. It should be noted that delay in the multipath information of MP_{RIS} obtained through simulation only includes a path delay of an RIS-UE segment, and therefore a path delay of a BS-RIS segment needs to be added. Since BS-RIS is a line-of-sight scenario, a delay of the BS-RIS segment

$${d}_{O}^{R} / c$$

is added when calculating delay of MP_{RIS} to obtain a total delay.
a total delay of the first multipath τ_{MP}_{_{RIS}} is calculated according to the following formula:

$${τ}_{{MP}_{RIS}} = {τ}_{RIS - UE} + \frac{{d}_{O}^{R}}{c} ;$$

where τ_{RIS-UE} denotes a delay of each multipath in the first multipath on an RIS-user segment; c denotes a speed of light; and

$${d}_{O}^{R}$$

denotes a distance from a center O of the base station to a center R of the RIS, which is 8.4 m in this embodiment.
Step 108. configuring the RIS to be made of a wave-absorbing material, setting a transmitting antenna at a transmitting end and a receiving antenna at a receiving end to be in an operating state, setting a receiving antenna and a transmitting antenna at the RIS to be in a non-operating state, and simulating a cascade link of a base station, the RIS and the user, so as to acquire multipath information of the second multipath.
Step 109. On the basis of the multipath information of the first multipath and the multipath information of the second multipath, extracting a channel impulse response of the cascade link of the base station, the RIS and the user to obtain a path loss, a delay power spectral density and an angular power spectral density, so as to analyze channel characteristics of a reconfigurable intelligent surface channel in a delay domain and an angular domain.

All multipath information in the propagation environment is integrated to construct a channel transfer function H_{i,q}(f) of an i^{th} transmitting antenna and a q^{th} receiving antenna pair to characterize signal attenuation and distortion during transmission:

$${H}_{i , q} ( f ) = {\sum }_{l = 1}^{L} \sqrt{{p}_{l}} {e}^{j {φ}_{l}} {e}^{- j 2 π f {τ}_{l}} ;$$

where L denotes a total number of multipaths between the i^{th} transmitting antenna and the q^{th} receiving antenna; the multipaths between the i^{th} transmitting antenna and the q^{th} receiving antenna include the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal; e is a natural constant, and j is an imaginary unit.

According to a measurement bandwidth of 160 MHz and a PN sequence length of 1023 used to verify accuracy of the modeling method, a frequency-domain sampling interval Δf is 0.156 MHz. Frequency-domain sampling is performed on H_{i,q}(f) according to a bandwidth of the transmit signal and a time-domain signal length to obtain a discrete channel transfer function.

An inverse fast Fourier transform is performed on the discrete channel transfer function to obtain a channel impulse response h_{i,q} of the i^{th} transmitting antenna and the q^{th} receiving antenna pair with the same sampling rate and length as verification data.

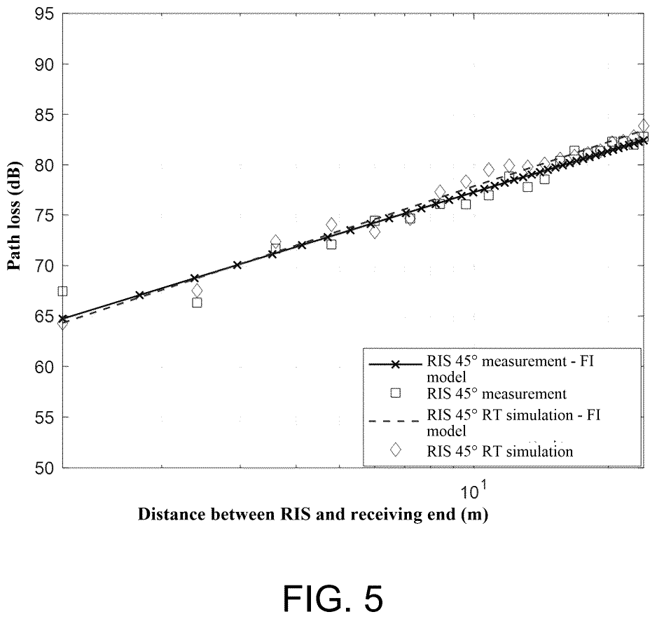

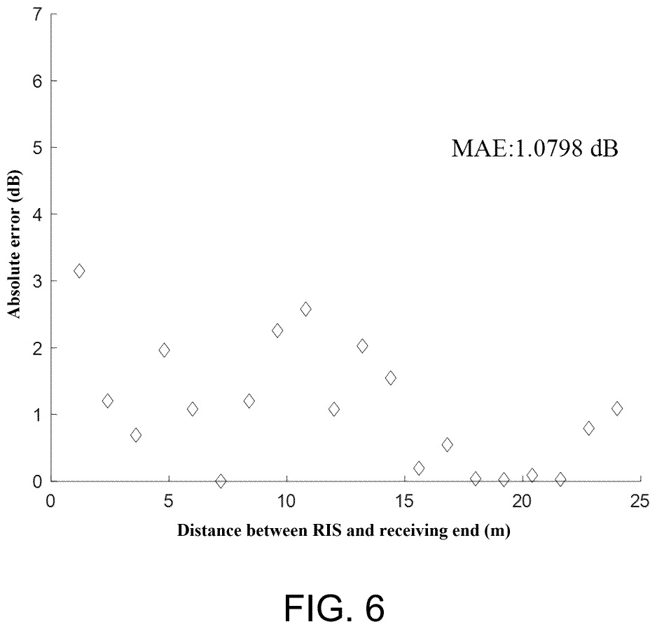

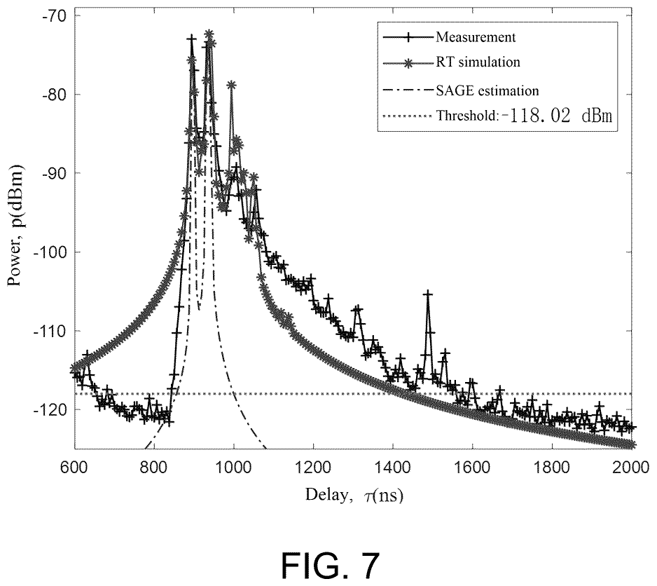

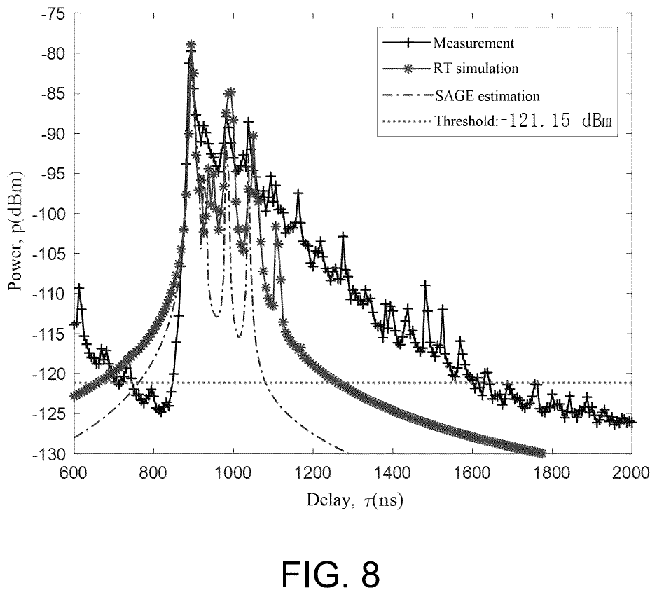

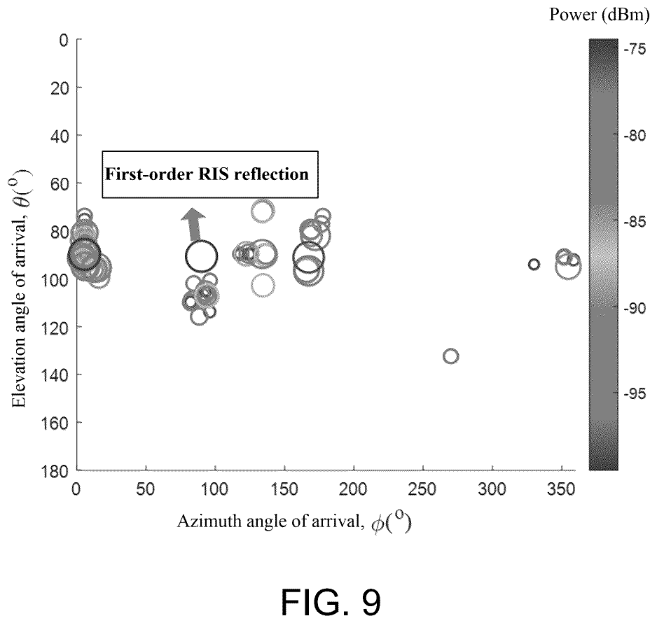

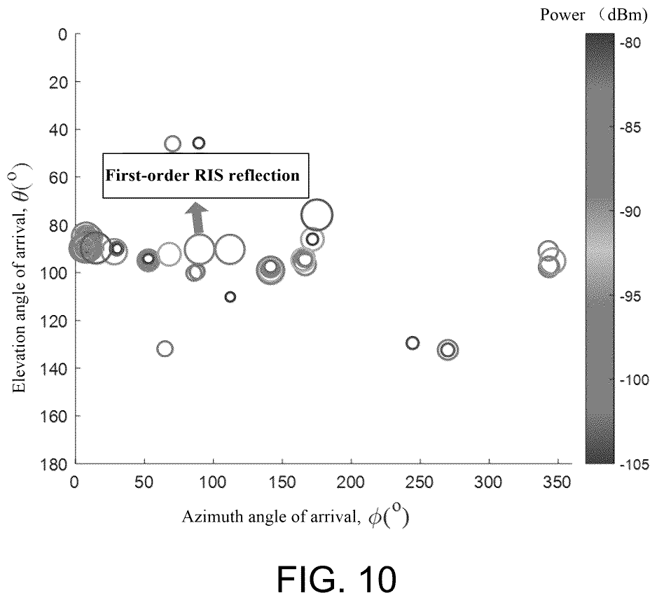

Channel impulse responses of different receiving antenna pairs are averaged along an antenna dimension, and a channel impulse response h(t) between the transmitting end and the receiving end is calculated according to the following formula:

$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$

where N_{Tx} denotes a number of antenna arrays at the transmitting end; and N_{Rx} denotes a number of antenna arrays at the receiving end. In this embodiment, a value of N_{Tx} is 64, and a value of N_{Rx} is 32. Comparison results of path loss, delay power spectral density, and angular power spectral density with verification data are shown in FIGS. 5-10.

The stepwise-simulation-based ray tracing modeling method for a reconfigurable intelligent surface (RIS) channel provided in the embodiment of the present invention may be applied to static ray-tracing simulation software, supports RIS channel simulation in any frequency band and any scenario, such that deterministic modeling methods for RISs are enriched, RIS channel parameters can be acquired with less manpower, fewer material resources and lower time costs, and channel characteristic analysis of simulation results has guiding significance for the application and deployment of RISs in actual communication systems.

Based on the same inventive concept, an embodiment of the present invention further provides a stepwise-simulation-based ray tracing modeling system for an RIS channel. Since a principle by which the system solves problems is similar to that of the foregoing stepwise-simulation-based ray tracing modeling method for an RIS channel, implementation of the system may refer to the implementation of the stepwise-simulation-based ray tracing modeling method for an RIS channel, which will not be repeated herein.

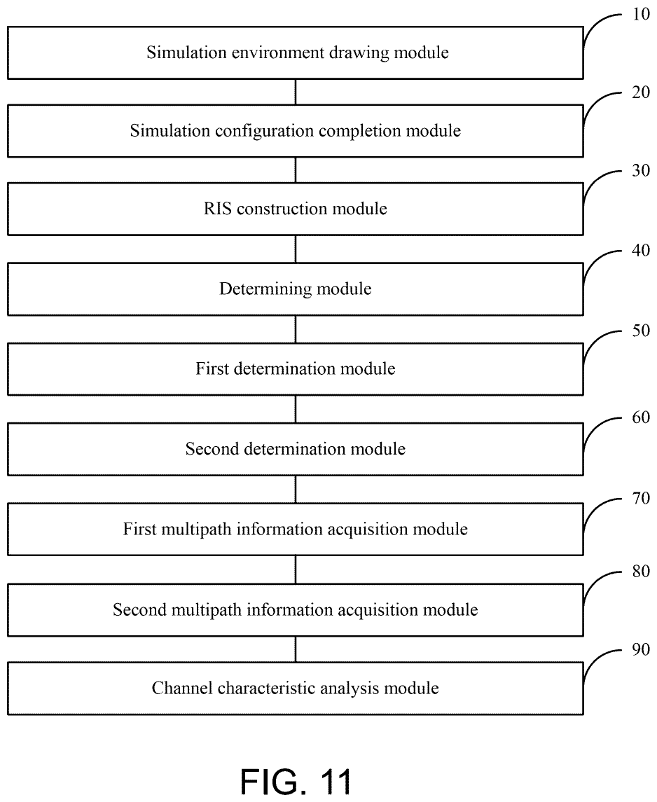

In another embodiment, a stepwise-simulation-based ray tracing modeling system for a reconfigurable intelligent surface (RIS) channel provided by the embodiment of the present invention is shown in FIG. 11, including:
a simulation environment drawing module 10, configured to determine a simulation environment layout and a material to be used, so as to draw a simulation environment;
a simulation configuration completion module 20, configured to determine antenna parameters, a transceiving end layout and a signal center frequency to complete simulation configuration;
an RIS construction module 30, configured to determine deployment position and size of an RIS to complete the construction of the RIS;
a determining module 40, configured to determine whether a transmitted signal is reflected via the RIS;
a first determination module 50, configured to determine a multipath where the transmitted signal reaches a user after being reflected via the RIS as a first multipath when a transmitted signal is reflected via the RIS;
a second determination module 60, configured to determine a multipath where the transmitted signal reaches the user without being reflected via the RIS as a second multipath when a transmitted signal is not reflected via the RIS;
a first multipath information acquisition module 70, configured to perform stepwise simulation to acquire multipath information of the first multipath, where the multipath information includes phase, delay and power of the multipath;
a second multipath information acquisition module 80, configured to configure the RIS to be made of a wave-absorbing material, set a transmitting antenna at a transmitting end and a receiving antenna at a receiving end to be in an operating state, set a receiving antenna and a transmitting antenna at the RIS to be in a non-operating state, and simulate a cascade link of a base station, the RIS and the user, so as to acquire multipath information of the second multipath; and
a channel characteristic analysis module 90, configured to extract a channel impulse response of the cascade link of the base station, the RIS and the user to obtain a path loss, a delay power spectral density and an angular power spectral density on the basis of the multipath information of the first multipath and the multipath information of the second multipath, so as to analyze channel characteristics of a reconfigurable intelligent surface channel in a delay domain and an angular domain.

By way of example, the simulation configuration completion module includes:
a first determination unit, configured to determine an antenna type, an antenna polarization mode and an antenna ray-tracing range, point layouts of a transmitting end and a receiving end, a transmitting antenna type matched with the transmitting end, a receiving antenna type matched with the receiving end, a received power threshold of the receiving end, a transmitted signal type, a transmitted signal center frequency, and a transmitted signal bandwidth in the simulation environment;
a second determination unit, configured to determine a dielectric constant of the material according to the transmitted signal center frequency to complete simulation configuration;
a first setting unit, configured to set simulation propagation mechanisms and a maximum order of each propagation mechanism; and
a second setting unit, configured to set output simulation results, where the simulation results include three types of multipath information, namely multipath phase, delay, and power, as well as azimuth angle of arrival and elevation angle of arrival.

By way of example, the RIS construction module includes:
a received power acquisition unit, configured to arrange receiving points on the RIS at half-wavelength intervals to obtain received power at the RIS; and
a first multipath information acquisition unit, configured to set a transmitting point at a center of the RIS to acquire multipath information of the first multipath.

By way of example, the first multipath information acquisition module includes:
a first simulation unit, configured to set a transmitting antenna at the transmitting end and a receiving antenna at the RIS to be in an operating state, set a transmitting antenna at the RIS and a receiving antenna at the receiving end to be in a non-operating state, and perform base station-RIS segment simulation;
a second simulation unit, configured to obtain received power and phase of each receiving point on the RIS from the base station through simulation; and
a first calculation unit, configured to calculate a total received power P_{RIS} at the RIS according to the following formula:

$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$

where M denotes a total number of rows of receiving points in a horizontal direction of the RIS, and N denotes a total number of columns of receiving points in a vertical direction of the RIS; the RIS includes a total of M×N receiving points; P_{m,n} denotes received power of a receiving point in an m^{th} row and an n^{th} column of the RIS; φ_{m,n} denotes a phase of the receiving point in the m^{th} row and the n^{th} column of the RIS; and Φ_{m,n} denotes a coding phase of the receiving point in the m^{th} row and the n^{th} column of the RIS; and Φ_{m,n}=mod(k(v_{m,n}v^{T}−v_{m,n}v^{R}),2π), where k denotes a wave number, k=2π/λ, λ denotes a wavelength; v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to a user; e is a natural constant, and j is an imaginary unit.

A third simulation unit, configured to simulate a link of the RIS and the user by taking the RIS as a secondary transmitting source, and a direction of a line connecting the RIS and the user as a reflection direction, a main lobe width of the RIS as a ray-tracing range, thereby obtaining the first multipath that reaches the user after being reflected via the RIS.

A second calculation unit, configured to calculate a total delay of the first multipath τ_{MP}_{_{RIS}} according to the following formula:

$${τ}_{{MP}_{RIS}} = {τ}_{RIS - UE} + \frac{{d}_{O}^{R}}{c} ;$$

where τ_{RIS-UE} denotes a delay of each multipath in the first multipath on an RIS-user segment; c denotes a speed of light; and

$${d}_{O}^{R}$$

denotes a distance from a center O of the base station to a center R of the RIS.

By way of example, the channel characteristic analysis module includes:
a construction unit, configured to construct a channel transfer function H_{i,q}(f) of an i^{th} transmitting antenna and a q^{th} receiving antenna pair to characterize signal attenuation and distortion during transmission:

$${H}_{i , q} ( f ) = {\sum }_{l = 1}^{L} \sqrt{{p}_{l}} {e}^{j {φ}_{l}} {e}^{- j 2 π ft {τ}_{l}} ;$$

where L denotes a total number of multipaths between the i^{th} transmitting antenna and the q^{th} receiving antenna; the multipaths between the i^{th} transmitting antenna and the q^{th} receiving antenna include the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal; e is a natural constant, and j is an imaginary unit.
a frequency-domain sampling unit, configured to perform frequency-domain sampling on H_{i,q}(f) according to a bandwidth of the transmit signal and a time-domain signal length to obtain a discrete channel transfer function;
an inverse fast Fourier transform unit, configured to perform an inverse fast Fourier transform on the discrete channel transfer function to obtain a channel impulse response h_{i,q} of the i^{th} transmitting antenna and the q^{th} receiving antenna pair with the same sampling rate and length as verification data; and
a third calculation unit, configured to average channel impulse responses of different receiving antenna pairs along an antenna dimension, and calculate a channel impulse response h(t) between the transmitting end and the receiving end according to the following formula:

$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$

where N_{Tx} denotes a number of antenna arrays at the transmitting end; and N_{Rx} denotes a number of antenna arrays at the receiving end.

More specific operating processes of the above modules may refer to the corresponding contents disclosed in the foregoing embodiments and will not be repeated herein.

In another embodiment, the present invention provides a computing device, including a processor and a memory, where when the processor executes computer programs stored in the memory, the steps of the above stepwise-simulation-based ray tracing modeling method for an RIS channel are implemented.

More specific processes of the above method may refer to the corresponding contents disclosed in the foregoing embodiments and will not be repeated herein.

In another embodiment, the present invention provides a computer-readable storage medium for storing a computer program, where when the computer program is executed by the processor, the steps of the above stepwise-simulation-based ray tracing modeling method for an RIS channel are implemented.

More specific processes of the above method may refer to the corresponding contents disclosed in the foregoing embodiments and will not be repeated herein.

Each embodiment of the specification is described in a progressive manner, each embodiment focuses on differences from other embodiments, and the same or similar parts between the embodiments may refer to each other. Since the system, device and storage media disclosed in the embodiments correspond to the method disclosed in the embodiments, the description is simple, and reference can be made to the method description.

Those skilled in the art can clearly understand that the technology in the embodiments of the present invention may be implemented by means of software plus a general-purpose hardware platform. On the basis of the understanding, the technical solution in the embodiments of the present invention, or the parts that contribute to the prior art may be embodied in a form of a software product in essence or a part contributing to the prior art, and the computer software product can be stored in a storage medium (for example, ROM/RAM, magnetic disks, optical discs, and the like), and includes a plurality of instructions for enabling a computer device (which may be a personal computer, server, or network device, etc.) to execute the method described in various embodiments or some parts of the embodiments of the present invention.

The present invention has been described in detail above in conjunction with specific embodiments and exemplary examples; however, these descriptions should not be construed as limiting the present invention. Those skilled in the art will understand that various equivalent substitutions, modifications, or improvements may be made to the technical solutions and embodiments of the present invention without departing from the spirit and scope of the present invention, and all such substitutions, modifications, or improvements shall fall within the scope of the present invention. Accordingly, the scope of protection of the present invention shall be defined by the appended claims.

What is claimed is:

1. A stepwise-simulation-based ray tracing modeling method for a reconfigurable intelligent surface (RIS) channel, comprising:
determining a simulation environment layout and a material to be used, so as to draw a simulation environment;
determining antenna parameters, a transceiving end layout and a signal center frequency to complete a simulation configuration;
determining a deployment position and a size of an RIS to complete a construction of a RIS;
determining whether a transmitted signal is reflected via the RIS;
if the transmitted signal is reflected via the RIS, using a multipath where the transmitted signal reaches a user after being reflected via the RIS as a first multipath;
if the transmitted signal is not reflected via the RIS, using a multipath where the transmitted signal reaches the user without being reflected via the RIS as a second multipath;
performing a stepwise simulation to acquire multipath information of the first multipath, wherein the multipath information comprises a phase, a delay and a power of the multipath;
configuring the RIS to be made of a wave-absorbing material, setting a transmitting antenna at a transmitting end and a receiving antenna at a receiving end to be in an operating state, setting a receiving antenna and a transmitting antenna at the RIS to be in a non-operating state, and simulating a cascade link of a base station, the RIS and the user, so as to acquire multipath information of the second multipath; and
on the basis of the multipath information of the first multipath and the multipath information of the second multipath, extracting a channel impulse response of the cascade link of the base station, the RIS and the user to obtain a path loss, a delay power spectral density and an angular power spectral density, so as to analyze channel characteristics of the reconfigurable intelligent surface channel in a delay domain and an angular domain.

2. The stepwise-simulation-based ray tracing modeling method for an RIS channel according to claim 1, wherein the determining antenna parameters, a transceiving end layout and a signal center frequency to complete a simulation configuration comprises:
determining an antenna type, an antenna polarization mode and an antenna ray-tracing range, point layouts of the transmitting end and the receiving end, a transmitting antenna type matched with the transmitting end, a receiving antenna type matched with the receiving end, a received power threshold of the receiving end, a transmitted signal type, a transmitted signal center frequency, and a transmitted signal bandwidth in the simulation environment;
determining a dielectric constant of the material according to the transmitted signal center frequency to complete the simulation configuration;
setting simulation propagation mechanisms and a maximum order of each of the propagation mechanisms; and
setting output simulation results, wherein the simulation results comprise the phase, the delay and the power of the multipath, a azimuth angle of arrival and an elevation angle of arrival.

3. The stepwise-simulation-based ray tracing modeling method for an RIS channel according to claim 1, wherein the determining a deployment position and a size of an RIS to complete a construction of the RIS comprises:
arranging receiving points on the RIS at half-wavelength intervals to obtain received power at the RIS; and
setting a transmitting point at a center of the RIS to acquire the multipath information of the first multipath.

4. The stepwise-simulation-based ray tracing modeling method for an RIS channel according to claim 1, wherein the performing a stepwise simulation to acquire multipath information of the first multipath comprises:
setting the transmitting antenna at the transmitting end and the receiving antenna at the RIS to be in the operating state, setting the transmitting antenna at the RIS and the receiving antenna at the receiving end to be in the non-operating state, and performing base station-RIS segment simulation; and
obtaining received power and phase of each receiving point on the RIS from the base station through simulation;
a total received power P_{RIS} at the RIS is calculated according to the following formula:
$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$
wherein M denotes a total number of rows of receiving points in a horizontal direction of the RIS, N denotes a total number of columns of the receiving points in a vertical direction of the RIS, the RIS comprises a total of M×N receiving points; P_{m,n} denotes received power of a receiving point in an m^{th} row and an n^{th} column of the RIS; φ_{m,n} denotes a phase of the receiving point in the m^{th} row and the n^{th} column of the RIS; and Φ_{m,n} denotes a coding phase of the receiving point in the m^{th} row and the n^{th} column of the RIS; and Φ_{m,n}=mod(k(v_{m,n}v^{T}−v_{m,n}v^{R}),2π), wherein k denotes a wave number, k=2π/λ, λ denotes a wavelength, v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to the user; e is a natural constant; and j is an imaginary unit;
simulating a link of the RIS and the user by taking the RIS as a secondary transmitting source, and a direction of a line connecting the RIS and the user as a reflection direction, a main lobe width of the RIS as a ray-tracing range, thereby obtaining the first multipath that reaches the user after being reflected via the RIS;
a total delay of the first multipath τ_{MP}_{_{RIS}} is calculated according to the following formula:
$${τ}_{{MP}_{RIS}} = {τ}_{RIS - UE} + \frac{{d}_{O}^{R}}{c} ;$$
wherein τ_{RIS-UE} denotes a delay of each multipath of the first multipath on an RIS-user segment; c denotes a speed of light; and
$${d}_{O}^{R}$$
denotes a distance from a center O of the base station to the center R of the RIS.

5. The stepwise-simulation-based ray tracing modeling method for an RIS channel according to claim 1, wherein the on the basis of the multipath information of the first multipath and the multipath information of the second multipath, extracting a channel impulse response of the cascade link of the base station, the RIS and the user to obtain a path loss, a delay power spectral density and an angular power spectral density, so as to analyze channel characteristics of the reconfigurable intelligent surface channel in a delay domain and an angular domain comprises:
constructing a channel transfer function H_{i,q}(f) of an i^{th} transmitting antenna and a q^{th} receiving antenna pair to characterize signal attenuation and distortion during transmission:
$${H}_{i , q} ( f ) = {\sum }_{l = 1}^{L} \sqrt{{p}_{l}} {e}^{j {φ}_{l}} {e}^{- j 2 π ft {τ}_{l}} ;$$
wherein L denotes a total number of multipaths between the i^{th} transmitting antenna and the q^{th} receiving antenna; the multipaths between the i^{th} transmitting antenna and the q^{th} receiving antenna comprise the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal; e is a natural constant, and j is an imaginary unit;
performing frequency-domain sampling on H_{i,q}(f) according to a bandwidth of the transmit signal and a time-domain signal length to obtain a discrete channel transfer function;
performing an inverse fast Fourier transform on the discrete channel transfer function to obtain a channel impulse response h_{i,q} of the i^{th} transmitting antenna and the q^{th} receiving antenna pair with the same sampling rate and length as verification data;
averaging channel impulse responses of different receiving antenna pairs along an antenna dimension, and calculating a channel impulse response h(t) between the transmitting end and the receiving end according to the following formula:
$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$
wherein N_{Tx} denotes a number of antenna arrays at the transmitting end; and N_{Rx} denotes a number of antenna arrays at the receiving end.

6. A stepwise-simulation-based ray tracing modeling system for a reconfigurable intelligent surface (RIS) channel, comprising:
a simulation environment drawing module, configured to determine a simulation environment layout and a material to be used, so as to draw a simulation environment;
a simulation configuration completion module, configured to determine antenna parameters, a transceiving end layout and a signal center frequency to complete a simulation configuration;
an RIS construction module, configured to determine a deployment position and a size of an RIS to complete a construction of the RIS;
a determining module, configured to determine whether a transmitted signal is reflected via the RIS;
a first determination module, configured to determine a multipath where the transmitted signal reaches a user after being reflected via the RIS as a first multipath when a transmitted signal is reflected via the RIS;
a second determination module, configured to determine a multipath where the transmitted signal reaches the user without being reflected via the RIS as a second multipath when the transmitted signal is not reflected via the RIS;
a first multipath information acquisition module, configured to perform a stepwise simulation to acquire multipath information of the first multipath, wherein the multipath information comprises a phase, a delay and a power of the multipath;
a second multipath information acquisition module, configured to configure the RIS to be made of a wave-absorbing material, set a transmitting antenna at a transmitting end and a receiving antenna at a receiving end to be in an operating state, set a receiving antenna and a transmitting antenna at the RIS to be in a non-operating state, and simulate a cascade link of a base station, the RIS and the user, so as to acquire multipath information of the second multipath; and
a channel characteristic analysis module, configured to extract a channel impulse response of the cascade link of the base station, the RIS and the user to obtain a path loss, a delay power spectral density and an angular power spectral density on the basis of the multipath information of the first multipath and the multipath information of the second multipath, so as to analyze channel characteristics of the reconfigurable intelligent surface channel in a delay domain and an angular domain.

7. The stepwise-simulation-based ray tracing modeling system for an RIS channel according to claim 6, wherein the simulation configuration completion module comprises:
a first determination unit, configured to determine an antenna type, an antenna polarization mode and an antenna ray-tracing range in the simulation environment; point layouts of the transmitting end and the receiving end, a transmitting antenna type matched with the transmitting end, a receiving antenna type matched with the receiving end, and a received power threshold of the receiving end; and a transmit signal type, a center frequency, and a signal bandwidth;
a second determination unit, configured to determine a dielectric constant of the material according to the transmitted signal center frequency to complete the simulation configuration;
a first setting unit, configured to set simulation propagation mechanisms and a maximum order of each of the propagation mechanisms; and
a second setting unit, configured to set output simulation results, wherein the simulation results comprise the phase, the delay and the power of the multipath, a azimuth angle of arrival and an elevation angle of arrival.

8. The stepwise-simulation-based ray tracing modeling system for an RIS channel according to claim 6, wherein the RIS construction module comprises:
a received power acquisition unit, configured to arrange receiving points on the RIS at half-wavelength intervals to obtain received power at the RIS; and
a first multipath information acquisition unit, configured to set a transmitting point at a center of the RIS to acquire the multipath information of the first multipath.

9. The stepwise-simulation-based ray tracing modeling system for an RIS channel according to claim 6, wherein the first multipath information acquisition module comprises:
a first simulation unit, configured to set the transmitting antenna at the transmitting end and the receiving antenna at the RIS to be in the operating state, set the transmitting antenna at the RIS and the receiving antenna at the receiving end to be in the non-operating state, and perform base station-RIS segment simulation;
a second simulation unit, configured to obtain received power and phase of each receiving point on the RIS from the base station through simulation; and
a first calculation unit, configured to calculate a total received power P_{RIS} at the RIS according to the following formula:
$${P}_{RIS} = {\vert {\sum }_{m = 1}^{M} {\sum }_{n = 1}^{N} \sqrt{{P}_{m , n}} {e}^{j ( {φ}_{m , n} + {Φ}_{m , n} )} \vert}^{2} ;$$
wherein M denotes a total number of rows of receiving points in a horizontal direction of the RIS, and N denotes a total number of columns of the receiving points in a vertical direction of the RIS; the RIS comprises a total of M×N receiving points; and P_{m,n} denotes received power of a receiving point in an m^{th} row and an n^{th} column of the RIS; φ_{m,n} denotes a phase of the receiving point in the m^{th} row and the n^{th} column of the RIS; and Φ_{m,n} denotes a coding phase of the receiving point in the m^{th} row and the n^{th} column of the RIS; and Φ_{m,n}=mod(k(v_{m,n}v^{T}−v_{m,n}v^{R}),2π), wherein k denotes a wave number, k=2π/λ, λ denotes a wavelength; v_{m,n} denotes a vector from a center of the RIS to the receiving point in the m^{th} row and the n^{th} column of the RIS; v^{T} denotes a unit vector from the center of the RIS to the base station; v^{R} denotes a unit vector from the center of the RIS to the user; e is a natural constant, and j is an imaginary unit;
a third simulation unit, configured to simulate a link of the RIS and the user by taking the RIS as a secondary transmitting source, and a direction of a line connecting the RIS and the user as a reflection direction, a main lobe width of the RIS as a ray-tracing range, thereby obtaining the first multipath that reaches the user after being reflected via the RIS;
a second calculation unit, configured to calculate a total delay of the first multipath τ_{MP}_{_{RIS}} according to the following formula:
$${τ}_{{MP}_{RIS}} = {τ}_{RIS - UE} + \frac{{d}_{O}^{R}}{c} ;$$
wherein τ_{RIS-UE} denotes a delay of each multipath of the first multipath on an RIS-user segment; c denotes a speed of light; and
$${d}_{O}^{R}$$
denotes a distance from a center O of the base station to the center R of the RIS.

10. The stepwise-simulation-based ray tracing modeling system for an RIS channel according to claim 6, wherein the channel characteristic analysis module comprises:
a construction unit, configured to construct a channel transfer function H_{i,q}(f) of an i^{th} transmitting antenna and a q^{th} receiving antenna pair to characterize signal attenuation and distortion during transmission:
$${H}_{i , q} ( f ) = {\sum }_{l = 1}^{L} \sqrt{{p}_{l}} {e}^{j {φ}_{l}} {e}^{- j 2 π ft {τ}_{l}} ;$$
wherein L denotes a total number of multipaths between the i^{th} transmitting antenna and the q^{th} receiving antenna; the multipaths between the i^{th} transmitting antenna and the q^{th} receiving antenna comprise the first multipath and the second multipath; pₗ denotes a power of an l^{th} multipath; φₗ denotes a phase of the l^{th} multipath; τₗ denotes a delay of the l^{th} multipath, f denotes a frequency of a transmitted signal; e is a natural constant, and j is an imaginary unit;
a frequency-domain sampling unit, configured to perform frequency-domain sampling on H_{i,q}(f) according to a bandwidth of the transmit signal and a time-domain signal length to obtain a discrete channel transfer function;
an inverse fast Fourier transform unit, configured to perform an inverse fast Fourier transform on the discrete channel transfer function to obtain a channel impulse response h_{i,q} of the i^{th} transmitting antenna and the q^{th} receiving antenna pair with the same sampling rate and length as verification data; and
a third calculation unit, configured to average channel impulse responses of different receiving antenna pairs along an antenna dimension, and calculate a channel impulse response h(t) between the transmitting end and the receiving end according to the following formula:
$$h ( t ) = \frac{1}{{N}_{Tx} {N}_{Rx}} {\sum }_{i = 1}^{{N}_{Tx}} {\sum }_{q = 1}^{{N}_{Rx}} {h}_{i , q} ;$$
wherein N_{Tx} denotes a number of antenna arrays at the transmitting end; and N_{Rx} denotes a number of antenna arrays at the receiving end.
